(19) United States
(12) Patent Application Publication
(10) Pub. No.: US 2026/0015822 A1
(43) Pub. Date: Jan. 15, 2026

(54) TRENCH AND FLEXIBLE PIPE JACK

(71) Applicant: Logan Teinert, Lubbock, TX (US)

(72) Inventor: Logan Teinert, Lubbock, TX (US)

(21) Appl. No.: 18/766,803

(22) Filed: Jul. 9, 2024

(51) Int. Cl. E02F 5/10; E02F 5/32; F16L 1/032; F16L 1/06

(52) U.S. Cl. CPC E02F 5/10; E02F 5/32; F16L 1/032; F16L 1/06

(57) ABSTRACT

A trench and flexible pipe jack apparatus for a skid steer, including a ripper blade attached to a frame with a back plate and two substantially parallel rib plates. A pipe feeder is attached to the rib plates behind the ripper blade. In operation, the jack apparatus is securably detached to a skid steer and the jack is lowered into the soil. As the skid steer moves forward, a trench is formed by the ripper blade urging soil from the trench and concurrently pipe is fed into a pipe tube assembly which deposits flexible pipe into the resulting trench.

### BACKGROUND

The skid steer is a versatile piece of heavy equipment equipped with lift arms that provide for the attachment of a wide variety of buckets, grading blades, trenchers attachments, plows, forks and other labor-saving tools and attachments. Skid steer loaders are known for their ability for “zero-radius” turns making them extremely maneuverable and valuable for applications that require a compact, powerful and agile loader or tool in confined workspaces. Similar to other front loader equipment, they can push material from on location to another, carry material in a bucket, grade soil and perform a variety of digging, trenching and other operations.

There are many situations calling for the deposition of flexible polypipe (e.g. water line pipe) or other flexible cable or pipes that are to be buried underground that a backhoe or other trenching equipment cannot address. These trenches must be dug by hand or other means. While specialized trenching equipment exists that can perform these operations for laying cable or flexible pipe in narrow trenches, this equipment is generally expensive, prone to breakdown, and operates at relatively slow speeds thereby increasing the time necessary to complete trenching operations. Such equipment generally provides only for creating the trench and does not include apparatus for installing the cable or flexible pipe into the trench during the trenching operation. Additional manual labor or other equipment is necessary to install the cable or pipe in the trench after the trenching operation is completed. Unless the pipe or cable is installed immediately or soon after the trench is dug, the likelihood of trench collapse before the pipe or cable is placed in the trench is quite high due to rain, wind, or soil shear among other natural processes thus requiring the trench to be dug again. Thus, there is a need for an apparatus that would take advantage of the skid steer platform for digging narrow furrows or trenches and provides for the deposition of flexible pipe and cable after the furrow or trench has been dug. The present invention addresses this need.

### SUMMARY OF THE INVENTION

The present technology relates to an apparatus and method for digging narrow trenches and depositing cable or pipe in the trench with a skid steer. The trench and flexible pipe jack, hereinafter “Jack,” is a modular unit consisting in part of a prefabricated metal or steel frame which may be attached to a skid steer or other piece of heavy equipment. The jack frame supports a ripper blade for creating a narrow trench or furrow and a pipe feeder into which flexible cable or pipe is fed. As the skid steer moves forward the ripper blade plows a trench or furrow and flexible cable or pipe is concurrently fed into the pipe feeder which deposits the flexible cable or pipe into the trench made by the ripper blade. Related objects and advantages of the invention will be apparent from the following description.

### BRIEF DESCRIPTION OF THE DRAWINGS

The details of one or more implementations are set forth in the drawings included in this application and which are further described below. Other features, objects, and advantages of the invention embodiments disclosed herein will be apparent from the description and figures.

FIG. 1 is a side view of an embodiment of the Jack invention attached to a skid steer disclosed herein;

FIG. 2 is a perspective view of an embodiment of the Jack invention disclosed herein;

FIG. 3 is a front view of an embodiment of the Jack with the pipe feeder shown in partial cutaway according to the invention disclosed herein; and,

FIG. 4 is a rear perspective view of an embodiment of the Jack invention disclosed herein.

### DETAILED DESCRIPTION

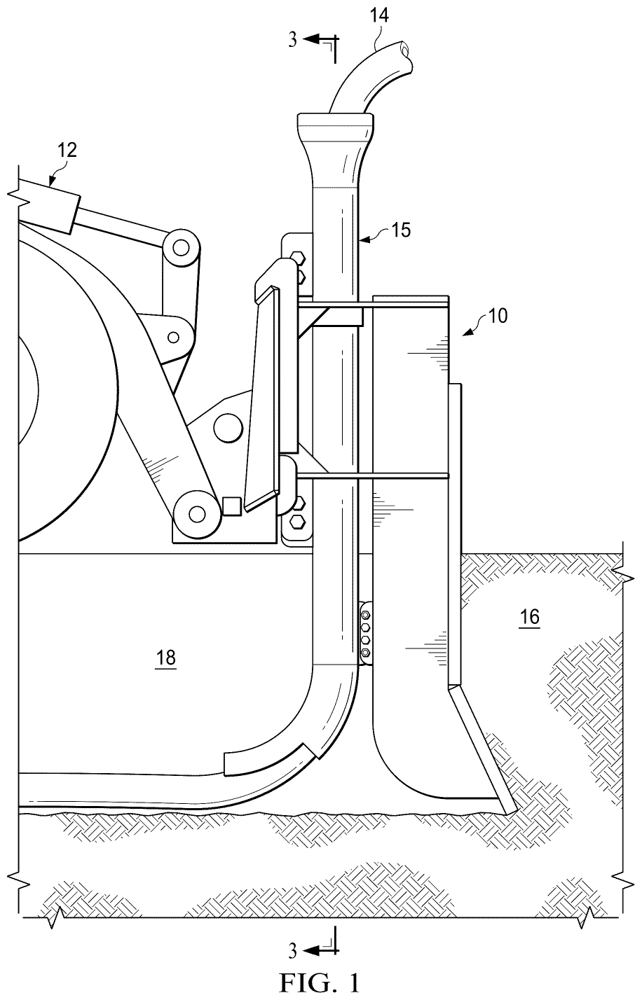

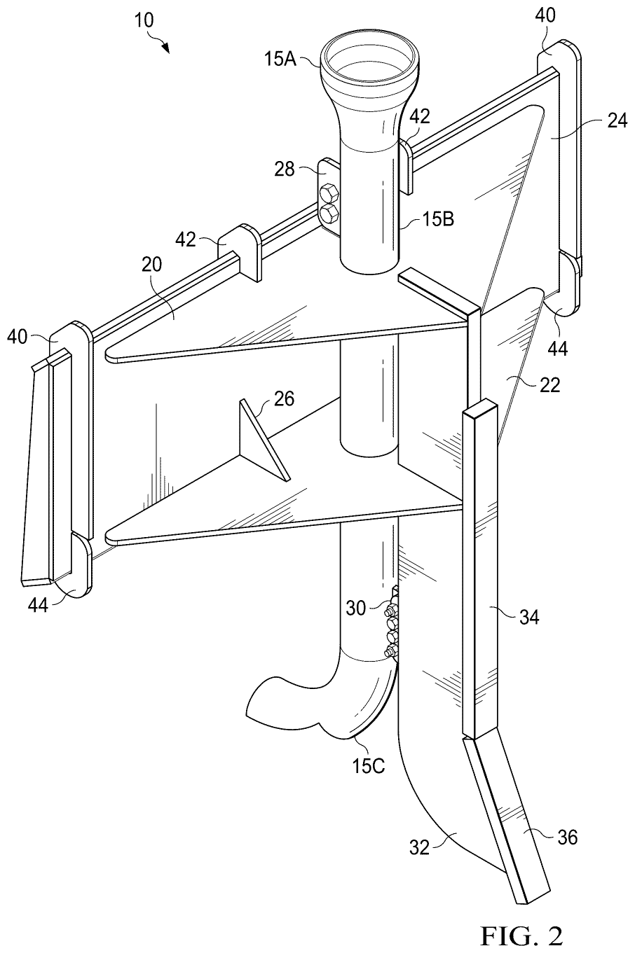

Turning to FIGS. 1 and 2, the Jack invention 10 is shown attached to the front of a skid steer 12. In this side view, as skid steer 12 moves in a forward direction, Jack 10 acts to plow through ground soil 16 and create a trench 18 into which cable or pipe 14 (collectively also referred to herein as “pipe”) is deposited via pipe feeder 15 as shown. In and embodiment, a blade or other apparatus (not shown) may be attached to the rear of the skid steer to fill the trench created by Jack 10 after pipe 14 is deposited in trench 18. The Jack 10 may be mounted to the skid steer with universal mounts, such as SAE J2513-Skid Steer Coupling standard, or other detachable mounting and coupling devices as are known in the art.

Turning to FIG. 2, a perspective view of the Jack 10 is shown. In this embodiment, Jack 10 includes upper rib plate 20 and lower rib plate 22 attached to back plate 24. Upper and lower rib plates 20, 22 are welded to back plate 24 with multiple triangle gussets 26 welded to back plate 24 and to rib plates 20, 22 to provide additional strength and support. Pipe feeder 15 comprises and pipe tube intake 15A, pipe tube 15B and pipe tube exit 15C. Pipe tube intake 15A includes a larger diameter opening on one end to provide for the ease of intake of pipe 14 into pipe tube 15B which directs the moving pipe 14 into the pipe tube exit 15C where the pipe is deposited into trench 18 as depicted in FIG. 1. Pipe feeder 15 is attached to upper rib plate with upper pipe mount assembly 28 and lower pipe mount assembly 30. The upper pipe mount assembly 28 comprises a metal tab welded to a surface of upper rib plate 20 with pre-formed holes and a second tab with pre-formed holes attached to the pipe tube 15B. The lower pipe mount assembly 30 comprises a metal tab secured to ripper blade 32 with pre-formed holes and a second tab with pre-formed holes secured to pipe tube 15B as shown. Pipe tube 15B is inserted through pre-formed holes in the upper and lower rib plates 20, 22 and a plurality of bolts are inserted through the pre-formed holes in the metal tabs of the upper pipe mount assembly 28 and lower pipe mount assembly 30 and secured with nuts thereby securing the pipe feeder to the Jack 10. In an embodiment the diameter of the pipe feeder assembly 15 is of sufficient size such that pipe 14 of outside diameters between 1.66 inches to 2.75 inches may easily transit pipe feeder assembly 15 for deposition into trench 18.

Ripper blade 32 is secured to upper and lower rib plates 20, 22 by welding or other attachment means as known in the art. Ripper blade 32 includes replaceable upper and lower wear plates 34, 36 which act as the leading edge of ripper blade 32 to plow and create trench 18 (shown in FIG. 1). Upper and lower wear plates 34, 36 may be removed and replaced on ripper blade 32 periodically as they wear over time from damage associated with trenching operations such as rock strikes or striking other unknown underground objects during trenching operations.

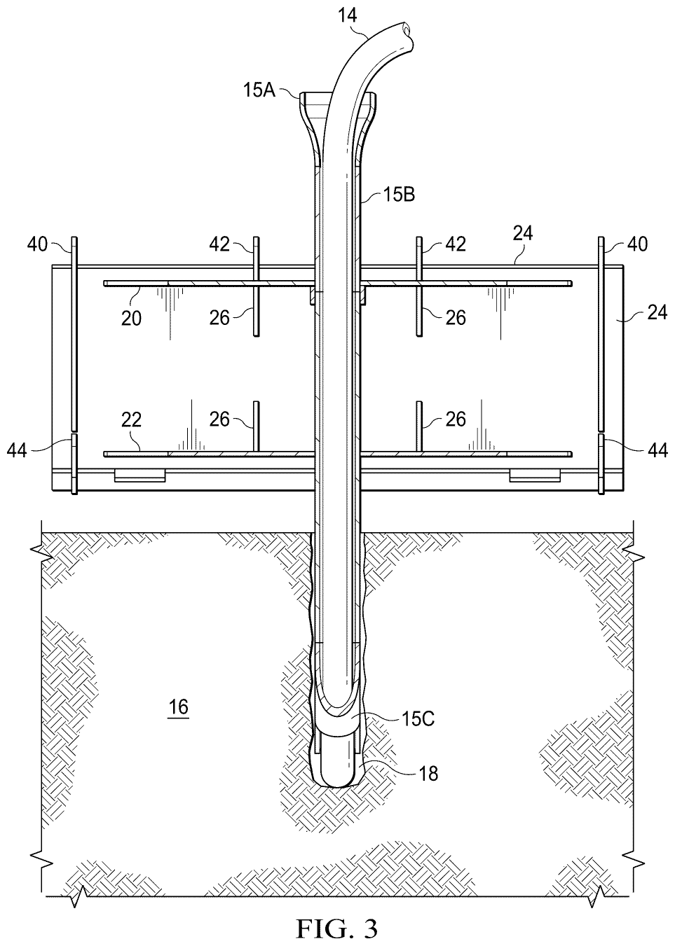

FIG. 3 depicts a front partial cutaway view of the Jack 10. Inside gussets 42 provided additional support and strength, along with triangle gussets 26, in connecting the back plate 24 to the upper and lower rib plates 20, 22 via weld or other attachment means as known in the art. Outside gussets 40 and bottom gussets 44 are welded to back plate 24 and provide additional reinforcement to back plate 24. In this view, pipe 14 is shown entering pipe tube intake 15A and transits through the length of pipe tube 15B and then is deposited in trench 18 as pipe 14 leaves pipe tube exit 15C.

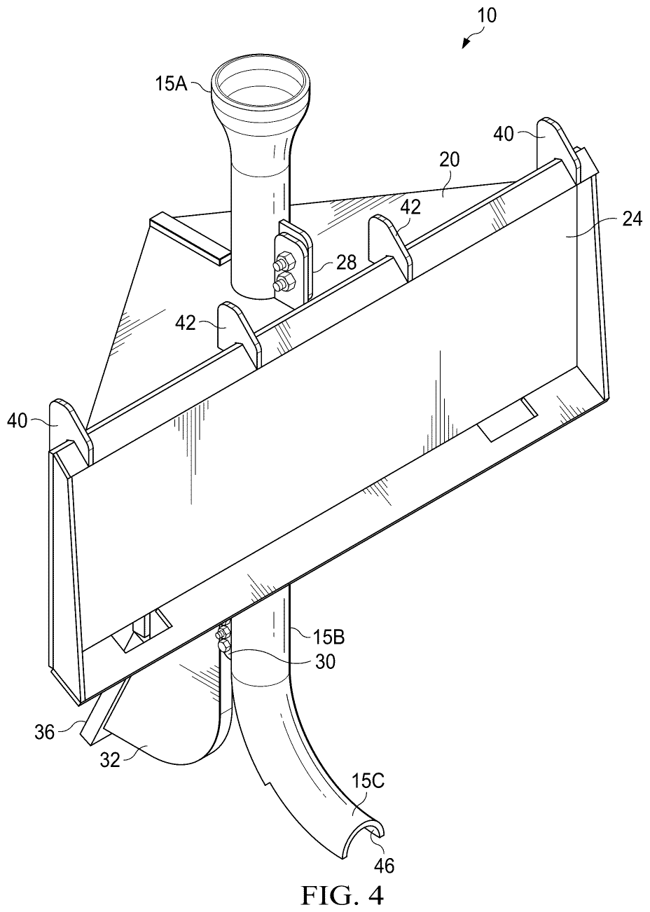

FIG. 4 is a rear perspective view of the Jack 10. In this depiction, pipe tube exit 15C is shown to include a portion where pipe tube exit 15C includes a semicircular portion 46 which acts to guide pipe 14 from a nearly vertical orientation as it transits pipe tube 15B and is oriented into a somewhat horizontal position as it is being deposited into trench 18 as shown in FIG. 3.

A method for using the Jack 10 to form a trench and deposit flexible pipe or cable therein is described as follows with reference to the embodiments shown in FIGS. 1-4. The Jack 10 is secured to the front end of skid steer 12 (as shown in FIG. 1). An initial length of pipe 14 is introduced into the pipe tube intake 15A sufficient to retain a length of pipe 14 within the pipe feeder 15. As the skid steer moves forward the Jack 10 is lowered into the soil 16 to the desired depth and begins to plow a trench 18 into the soil 16. Soil is dislodged by wear plates 34, 36 mounted to ripper blade 32 where it is directed up and out of the trench. Concurrently, pipe 14 transits the pipe feeder 15 and is deposited into trench 18. In an embodiment, a blade is mounted to the rear of skid steer 12 and acts to cover up trench 18 with soil as skid steer 12 is moving forward during trench operations. In another embodiment, the pipe 14 deposited in trench 18 is covered by other equipment to fill trench 18 or by hand with shovels as known in the art. In an embodiment, as the skid steer moves at faster velocity forward, the speed with which trenching and pipe laying operation will obviously increase. In an embodiment, the skid steer can operate, trench and deposit pipe with the Jack 10 at ground speeds typically between 1-7 miles per hour, thus greatly decreasing the time typically associated with digging a trench with one piece of equipment (or by hand) and then depositing pipe or cable with a second piece of equipment (or by hand). After trenching and pipe deposition operations are completed, the Jack 10 may be detached from the skid steer and stored until further use is desired. In an embodiment, if soil conditions are hard and compact, the user may use the Jack to pre-rip a length of trench to break up tough conosolidated soils before depositing pipe or cable in the trench.

It is to be understood that the implementations disclosed herein are not limited to particular apparatus or methods described which may, of course, vary. Moreover, the invention defined by the above paragraphs is not to be limited to particular details set forth in the above description, as many apparent variations thereof are possible without departing from the spirit or scope of the present disclosure. It is also to be understood that the terminology used herein is for the purpose of describing particular implementations only and is not intended to be limiting.

I claim:

1. A trench and flexible pipe jack, comprising:
an upper rib plate and a lower rib plate oriented substantially parallel to each other and attached to a back plate;
a plurality of triangle gussets attached to the upper rib plate and back plate;
a plurality of triangle gussets attached to the lower rib plate and back plate;
a ripper blade attached to the upper rib plate and the lower rib plate;
a detachable pipe feeder inserted through a hole in the upper rib plate and a hole in the lower rib plate and attached to the back plate with an upper pipe mount assembly and lower pipe mount assembly.

2. The apparatus of claim 1 further comprising a wear plate detachably secured to the ripper blade.

3. The apparatus of claim 1 wherein the pipe feeder comprises a pipe intake tube, a pipe tube and a pipe exit tube.

4. The apparatus of claim 1 further comprises a plurality of outside gussets attached to the back plate.

5. The apparatus of claim 1 further comprises a plurality of top gussets attached to the back plate.

6. The apparatus of claim 1 further comprising a plurality of bottom gussets attached to the back plate.

7. The apparatus of claim 1 wherein the pipe feeder is detachably secured to the back plate with a plurality of bolts and nuts.

8. A method for using a trench and flexible pipe jack, comprising:
engaging a jack with a skid steer, wherein the jack further comprises a soil-engaging ripper blade and a pipe-directing pipe feeder,
urging the skid steer with attached jack forward along a pipe burial route;
penetrating the soil along a pipe burial route to a predetermined depth to define a trench;
urging soil from the trench and on to a ground surface;
directing pipe through the pipe feeder and into the trench.
